(19) United States
(12) Patent Application Publication
(10) Pub. No.: US 2015/0183468 A1
(43) Pub. Date: Jul. 2, 2015

(54) VEHICLE FRONT SECTION STRUCTURE

(71) Applicant: TOYOTA JIDOSHA KABUSHIKI KAISHA, Toyota-shi (JP)

(72) Inventor: Masakazu SHIROOKA, Toyota-shi (JP)

(21) Appl. No.: 14/564,809

(22) Filed: Dec. 9, 2014

(30) Foreign Application Priority Data
Dec. 26, 2013 (JP) 2013-269982

(51) Int. Cl. B62D 25/08

(52) U.S. Cl. CPC B62D 25/082

(57) ABSTRACT

There is provided a vehicle front section structure including: a front side member that is disposed along a vehicle front-rear direction at a vehicle width direction outside of a vehicle front section, and that includes an inner member and an outer member forming a closed cross-section portion extending in the vehicle front-rear direction; and a projection member disposed at the vehicle width direction outside of the front side member and attached to the outer member so as to project out further toward the vehicle width direction outside than the front side member, wherein a weakened portion is provided at the inner member in a vehicle front-rear direction range where the projection member is disposed.

### CROSS-REFERENCE TO RELATED APPLICATION

This application is based on and claims priority under 35 USC 119 from Japanese Patent Application No. 2013-269982 filed on Dec. 26, 2013, the disclosure of which is incorporated by reference herein.

### BACKGROUND

1. Technical Field

The present invention relates to a vehicle front section structure.

2. Related Art

Vehicle front section structures exist in which a projection member such as a gusset is attached to a vehicle width direction outside face of a front side member, in order to improve collision performance in the event of a frontal collision (referred to hereafter as a “small overlap collision”) in which collision load is input at a vehicle width direction outside of the front side member (see for example Japanese Patent Application Laid-Open (JP-A) No. 2013-193572).

In such structures, however, the projection member functions as a reinforcement portion of the front side member in the event of a head-on collision, potentially lowering the energy absorption performance of the front side member.

### SUMMARY

In consideration of the above circumstances, an object of the present invention is to obtain a vehicle front section structure that enables a front side member to exhibit adequate energy absorption performance in the event of a head-on collision, even with a projection member attached at the vehicle width direction outside of the front side member.

A first aspect of the present invention provides a vehicle front section structure including:
a front side member that is disposed along a vehicle front-rear direction at a vehicle width direction outside of a vehicle front section, and that includes an inner member and an outer member forming a closed cross-section portion extending in the vehicle front-rear direction; and
a projection member disposed at the vehicle width direction outside of the front side member and attached to the outer member so as to project out further toward the vehicle width direction outside than the front side member,
wherein a weakened portion is provided at the inner member in a vehicle front-rear direction range where the projection member is disposed.

According to the above configuration, the front side member includes the inner member and the outer member forming a closed cross-section portion extending in the vehicle front-rear direction. The projection member is disposed at the vehicle width direction outside of the front side member, and is attached to the outer member so as to project out further toward the vehicle width direction outside than the front side member. Accordingly, in the event of a small overlap collision, collision load is input to the projection member, and transmitted from the projection member to the front side member. Moreover, in the present invention, the weakened portion is provided at the inner member in the vehicle front-rear direction range where the projection member is disposed. Accordingly, in the event of a head-on collision, the inner member deforms about the weakened portion in the vehicle front-rear direction range where the projection member is disposed. By contrast, the projection member suppresses deformation of the outer member, such that the inner member attempts to move toward the vehicle front side relative to the outer member. The inner member accordingly deforms while separating from the outer member, thereby absorbing collision energy.

A second aspect of the present invention provides the vehicle front section structure of the first aspect, wherein the projection member is disposed at a front end side of the front side member.

According to the above configuration, the projection member is disposed at the front end side of the front side member, such that collision load is input to the projection member at an early stage in the event of a small overlap collision. Moreover, due to providing the weakened portion at the front end side of the inner member, in the event of a head-on collision, the inner member deforms effectively from an early stage about the weakened portion on the upstream side in the load transmission direction.

A third aspect of the present invention provides the vehicle front section structure of the first or second aspect, wherein the weakened portion is provided at the inner member at an inner upright wall configuring a vehicle width direction inside face of the front side member.

According to the above configuration, in the front side member, the weakened portion is provided to the inner upright wall, weakening the upright wall on the vehicle width direction opposite side to the side reinforced by the projection member. Accordingly, in the event of a head-on collision, the two vehicle width direction sides of the front side member can be made to undergo relative displacement in the vehicle front-rear direction comparatively readily.

A fourth aspect of the present invention provides the vehicle front section structure of the third aspect, wherein:
the weakened portion includes a front side upright bead that is set toward the front side of the vehicle front-rear direction range where the projection member is disposed, that extends in a vehicle up-down direction, and that is indented toward the vehicle width direction outside; and
the inner member and the outer member are respectively formed with upright flange portions that are configured in upright wall shapes and are superimposed on each other along the vehicle width direction and spot welded together, and spot weld strike points are set on the upright flange portions at the vehicle rear side of the front side upright bead and within the vehicle front-rear direction range where the projection member is disposed.

According to the above configuration, the weakened portion includes the front side upright bead, and the front side upright bead is set toward the front side of the vehicle front-rear direction range where the projection member is disposed. Accordingly, in the event of a head-on collision, when collision load is input to the vehicle front-rear direction range of the front side member that is reinforced by the projection member, the inner member deforms about the weakened portion at an early stage. Since the front side upright bead extends in the vehicle up-down direction, indented toward the vehicle width direction outside, collision load from the vehicle front side causes the inner member to undergo buckling deformation about the front side upright bead, and a location of the inner member to the vehicle rear side of the front side upright bead attempts to deform diagonally toward the vehicle width direction inside and front side.

Note that in the present invention, the inner member and the outer member are respectively formed with the upright flange portions that are configured in upright wall shapes and are superimposed on each other along the vehicle width direction and spot welded together, and spot weld strike points are set on the upright flange portions at the vehicle rear side of the front side upright bead and within the vehicle front-rear direction range where the projection member is disposed. Accordingly, when the location of the inner member to the vehicle rear side of the front side upright bead attempts to undergo buckling deformation diagonally toward the vehicle width direction inside and front side, a shear load and a separation load act on spot welded locations of the upright flange portions that are to the vehicle rear side of the front side upright bead. These spot welded locations accordingly separate more efficiently than, for example, spot welded portions on which only shear force acts.

As described above, the vehicle front section structure of the present invention exhibits the excellent advantageous effect of enabling the front side member to exhibit adequate energy absorption performance in the event of a head-on collision, even with the projection member attached at the vehicle width direction outside of the front side member.

### BRIEF DESCRIPTION OF THE DRAWINGS

Exemplary embodiments of the present invention will be described in detail based on the following figures, wherein:

FIG. 1 is a perspective view illustrating a vehicle front section structure according to an exemplary embodiment of the present invention, in a state viewed diagonally from the width direction inside and rear upper side of the vehicle;

FIG. 2 is a plan view illustrating relevant portions of the vehicle front section structure in FIG. 1;

FIG. 3 is an enlarged cross-section, taken along line 3-3 in FIG. 1;

FIG. 4A is a plan view schematically illustrating a deformed state of the vehicle front section structure in FIG. 1 during a head-on collision, illustrating a state in which a front side member has begun to deform; and

FIG. 4B is a plan view schematically illustrating a deformed state of the vehicle front section structure in FIG. 1 during a head-on collision, illustrating a state in which the front side member has undergone further deformation from the state illustrated in FIG. 4A.

### DETAILED DESCRIPTION

### Exemplary Embodiment Configuration

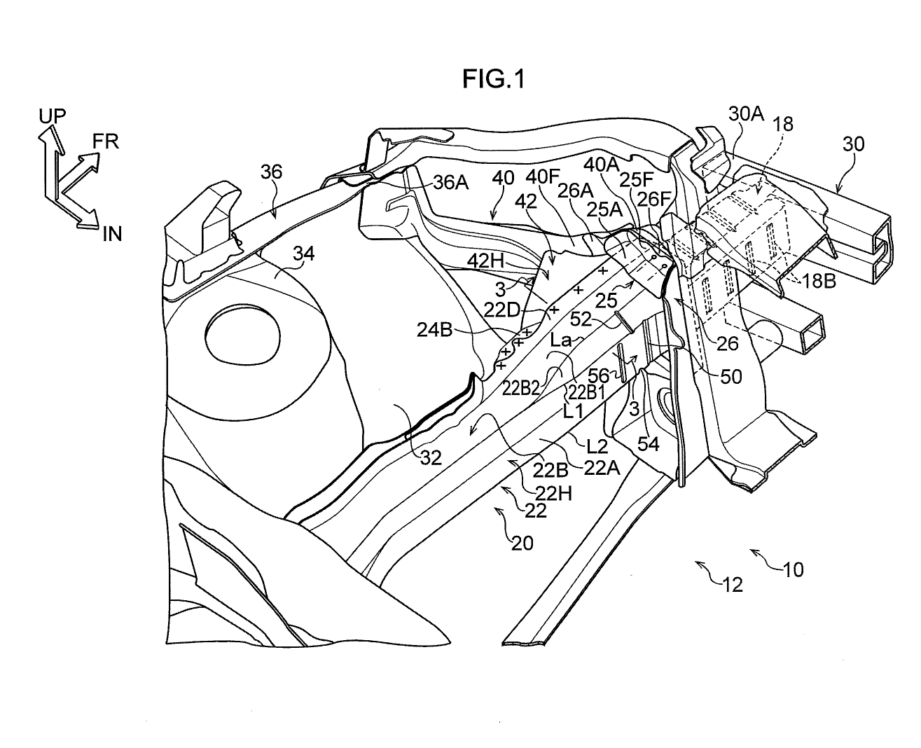

Explanation follows regarding a vehicle front section structure 10 according to an exemplary embodiment of the present invention, with reference to FIG. 1 to FIG. 4. In the drawings, the arrow FR indicates the vehicle front side, the arrow UP indicates the vehicle upper side, and the arrow IN indicates the vehicle width direction inside, as appropriate. In the following explanation, unless specifically indicated otherwise, reference to the front and rear, up and down, and left and right directions indicates the front and rear in the vehicle front-rear direction, up and down in the vehicle up-down direction, and left and right as facing in the direction of vehicle travel.

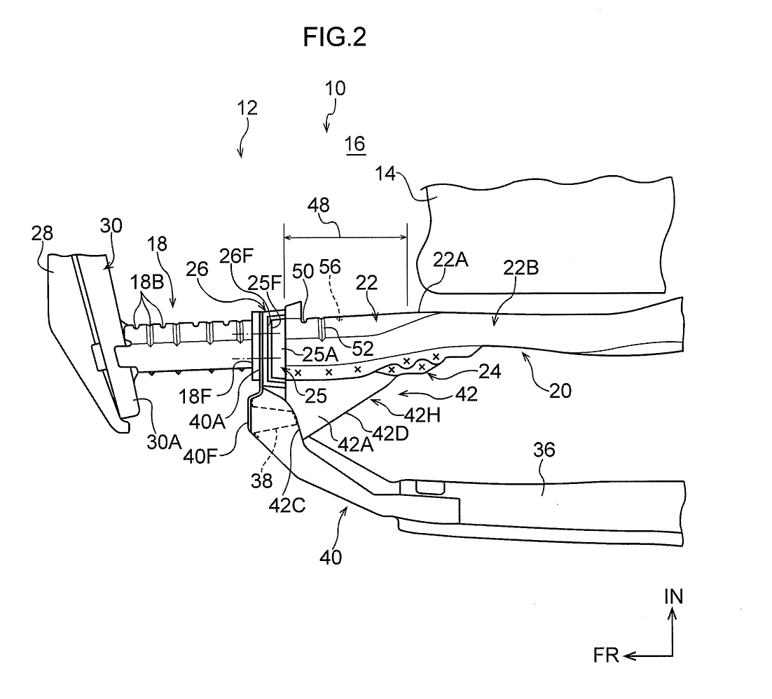

FIG. 1 is a perspective view illustrating the vehicle front section structure 10 according to the present exemplary embodiment, in a state viewed diagonally from the width direction inside and rear upper side of the vehicle. FIG. 2 is a plan view illustrating relevant portions of the vehicle front section structure 10. Note that both FIG. 1 and FIG. 2 illustrate the left side of a vehicle front section 12.

In an automobile (vehicle) applied with the vehicle front section structure 10 illustrated in FIG. 2, the vehicle front section 12, located at the vehicle front side of a cabin (vehicle compartment), not illustrated in the drawings, is formed with an engine compartment 16. A power unit 14, configured including an engine and a motor, for example, is housed inside the engine compartment 16. A pair of left and right front side members 20 are provided at both vehicle width direction side portions of a lower portion of the engine compartment 16.

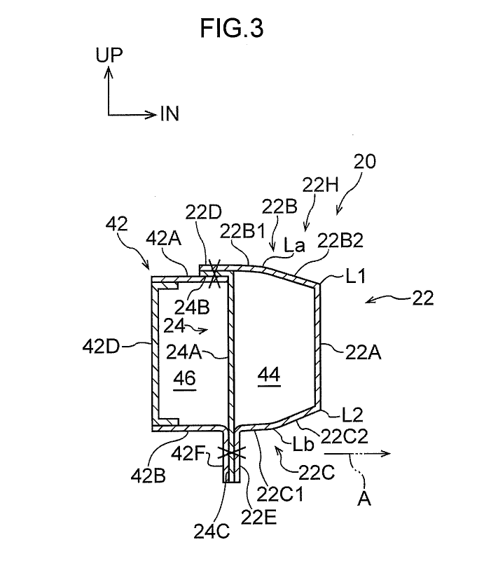

As illustrated in FIG. 1, the front side members 20 are disposed along the vehicle front-rear direction at both vehicle width direction outsides of the vehicle front section 12. FIG. 3 is an enlarged cross-section taken along line 3-3 in FIG. 1. As illustrated in FIG. 3, each front side member 20 is formed with a closed cross-section portion 44 extending along the vehicle front-rear direction, the closed cross-section portion 44 being configured by a front side inner member 22, serving as an inner member, disposed on the vehicle width direction inside, and a front side outer member 24, serving as an outer member, disposed on the vehicle width direction outside. The left and right front side members 20 support the power unit 14 illustrated in FIG. 2 through engine mounts, not illustrated in the drawings. Configuration of the front side members 20 is described in detail later.

As illustrated in FIG. 1, lateral plate portions 25A of coupling plates 25 are coupled to upper and lower faces of front end portions of each of the front side members 20 (front side inner members 22). The coupling plates 25 include front flanges 25F extending from front end portions of the lateral plate portions 25A. The front flanges 25F are provided in upright wall shapes in directions heading away from the upper and lower faces of the front side inner member 22. Note that vehicle width direction end portions of the lateral plate portions 25A and vehicle width direction end portions of the front flanges 25F are coupled together by side walls.

As illustrated in FIG. 2, the front flanges 25F of the coupling plate 25 are fastened by bolts to a front wall portion 26F of a plate shaped bracket 26 using fasteners (not illustrated in the drawings) (in the drawings, bolt-fastening lines are illustrated by single-dotted intermittent lines). The bracket 26 closes off an open end at the vehicle front side of the front side member 20. Note that the bracket 26 includes side walls that are superimposed with and joined to the side walls of the coupling plates 25.

A crash box 18 is disposed at the vehicle front side of each front side member 20. The crash box 18 is formed with a substantially rectangular closed cross-section profile as viewed from in front of the vehicle, and includes plural crash beads 18B in a row along the vehicle front-rear direction. The crash box 18 is accordingly set with lower rigidity (load bearing strength) than the front side member 20 with respect to axial compression load along the vehicle front-rear direction. A rear end portion of the crash box 18 is formed with a flange 18F. The flange 18F is fastened to both the front wall portion 26F of the bracket 26 and the front flanges 25F of the coupling plate 25 by fasteners (not illustrated in the drawings). Bumper reinforcement 30 is fixed to a front end portion of the crash box 18 by fastening with bolts or the like.

The bumper reinforcement 30 is disposed in the vehicle front section 12 with its length direction along the vehicle width direction, and includes a bumper extension portion 30A that extends further toward the vehicle width direction outside than the crash box 18. An absorber (shock absorbent member) 28 configured from a foamed body, for example, is attached to a front end face of the bumper reinforcement 30. The absorber 28 and the bumper reinforcement 30 are covered by a bumper cover, not illustrated in the drawings, thereby configuring a front bumper.

As illustrated in FIG. 1, a suspension tower 34 is provided at a vehicle width direction outside and at the vehicle upper side of a rear portion side of the front side member 20. A lower end portion of the suspension tower 34 is joined to the front side member 20. The suspension tower 34 supports an upper portion of a suspension device, not illustrated in the drawings, and a suspension arm provided to the suspension device is supported by a suspension member, not illustrated in the drawings, attached to the lower face of the front side member 20.

An end portion at an upper end side and vehicle width direction outside of the suspension tower 34 is joined to an apron upper member 36. The apron upper member 36 is disposed along the vehicle front-rear direction at the vehicle width direction outside and at the vehicle upper side of the front side member 20. The position of a front end of the apron upper member 36 is set at a position further to the vehicle rear side than the position of the front end of the front side member 20. Plural plate members are joined together to configure the apron upper member 36 with a closed cross-section structure extending along the vehicle front-rear direction.

A vehicle front side end portion of the suspension tower 34 is joined to a vehicle rear side end portion of an apron front 32. The apron front 32 is provided between the apron upper member 36 and the front side member 20. A vehicle width direction outside end portion of the apron front 32 is joined to a location on the vehicle width direction inside of the apron upper member 36, and a vehicle width direction inside end portion of the apron front 32 is joined to a location on the vehicle width direction outside of the front side member 20.

A front end portion of the apron upper member 36 and the front end portion of the front side member 20 are coupled together by an outrigger (also referred to as an “apron brace”) 40. Namely, the outrigger 40 extends from a joint portion with a front end portion 36A of the apron upper member 36 toward the front end side and vehicle width direction outside of the front side member 20, and is joined to the front side member 20 through the bracket 26 and the coupling plate 25. Note that as illustrated in FIG. 2, the position of a front end of the outrigger 40 (the position of a front face of a front portion 40F) is positioned further to the vehicle front side than the position of the front end of the front side member 20. Plural panels are joined together to configure the outrigger 40 illustrated in FIG. 1 with a closed cross-section structure.

A projection portion 26A that projects out from the bracket 26 is joined to an upper face of the front portion 40F of the outrigger 40 by welding. An upright wall shaped fixing portion 40A is formed protruding from the front end portion of the outrigger 40 toward the vehicle width direction inside. As illustrated in FIG. 2, the fixing portion 40A is interposed between the front wall portion 26F of the bracket 26 and the flange 18F of the crash box 18. The fixing portion 40A is joined to each of the front flanges 25F of the coupling plate 25, the front wall portion 26F of the bracket 26, and the flange 18F of the crash box 18 by fastening with fasteners (not illustrated in the drawings).

A bulkhead 38 is disposed inside the cross-section of the front portion 40F of the outrigger 40. Moreover, a gusset 42, serving as a projection member, is disposed at a front end side and a vehicle width direction outside of the front side member 20 at the vehicle rear side of the front portion 40F of the outrigger 40.

The gusset 42 is disposed at the vehicle width direction outside of the front side member 20, and is attached to the front side outer member 24 so as to project out toward the vehicle width direction outside with respect to the front side member 20. Note that the gusset 42 is an element that may be thought of as a widened portion of the front side member 20.

The gusset 42 is, for example, made out of metal, and is configured by joining plural plate members together. The gusset 42 includes a main body 42H that forms a hollow, substantially triangular column shape with the front side outer member 24. The main body 4211 of the gusset 42 includes an upper wall 42A and a lower wall 42B that form substantially triangular shapes in plan view of the vehicle (see FIG. 3), and also includes a front wall 42C that is joined to the front portion 40F of the outrigger 40, and an outer wall 42D that faces toward the vehicle width direction outside. The outer wall 42D of the gusset 42 is configured as an inclined wall portion that is inclined toward the vehicle width direction inside on progression toward the vehicle rear side, and a rear end portion of the outer wall 42D extends as far as the front side outer member 24 (see FIG. 3). The gusset 42 transmits collision load to the front side member 20 in the event of a small overlap collision, and is accordingly set with high deformation strength.

Detailed explanation now follows regarding the structure of the front side member 20 to which the gusset 42 is attached.

As illustrated in FIG. 1 and FIG. 3, the cross-section profile of the front side inner member 22 is formed with a shape open toward the vehicle width direction outside as viewed in cross-section taken along a plane orthogonal to the length direction of the front side member 20. A main body 22H of the front side inner member 22 includes an inner upright wall 22A configuring a vehicle width direction inside face of the front side member 20, an inner upper wall 22B configuring an upper face of the front side member 20, and an inner lower wall 22C (see FIG. 3) configuring a lower face of the front side member 20.

The inner upper wall 22B is formed in a substantially flat shape, and is slightly inclined toward the vehicle lower side on progression toward the vehicle width direction inside. At a front portion of the inner upper wall 22B, an upper wall inclined portion 22B2 configuring a location on the vehicle width direction inside has a slightly greater incline than an upper wall general portion 22B1 configuring a location on the vehicle width direction outside. Moreover, as illustrated in FIG. 3, the inner lower wall 22C is formed in a substantially flat shape, and is slightly inclined toward the vehicle upper side on progression toward the vehicle width direction inside. At a front portion of the inner lower wall 22C, a lower wall inclined portion 22C2 configuring a location on the vehicle width direction inside has a slightly greater incline than a lower wall general portion 22C1 configuring a location on the vehicle width direction outside.

As illustrated in FIG. 1, an upper flange 22D extends from a vehicle width direction outside end portion of the inner upper wall 22B. The upper flange 22D extends toward the vehicle width direction outside at a front portion of the front side inner member 22, and extends toward the vehicle upper side at a front-rear direction intermediate portion and rear portion of the front side inner member 22. Moreover, as illustrated in FIG. 3, a lower flange 22E, serving as an upright wall shaped upright flange portion, extends from a vehicle width direction outside end portion of the inner lower wall 22C toward the vehicle lower side. A front portion of the lower flange 22E is set within a vehicle front-rear direction range 48 where the gusset 42, illustrated in FIG. 2, is disposed.

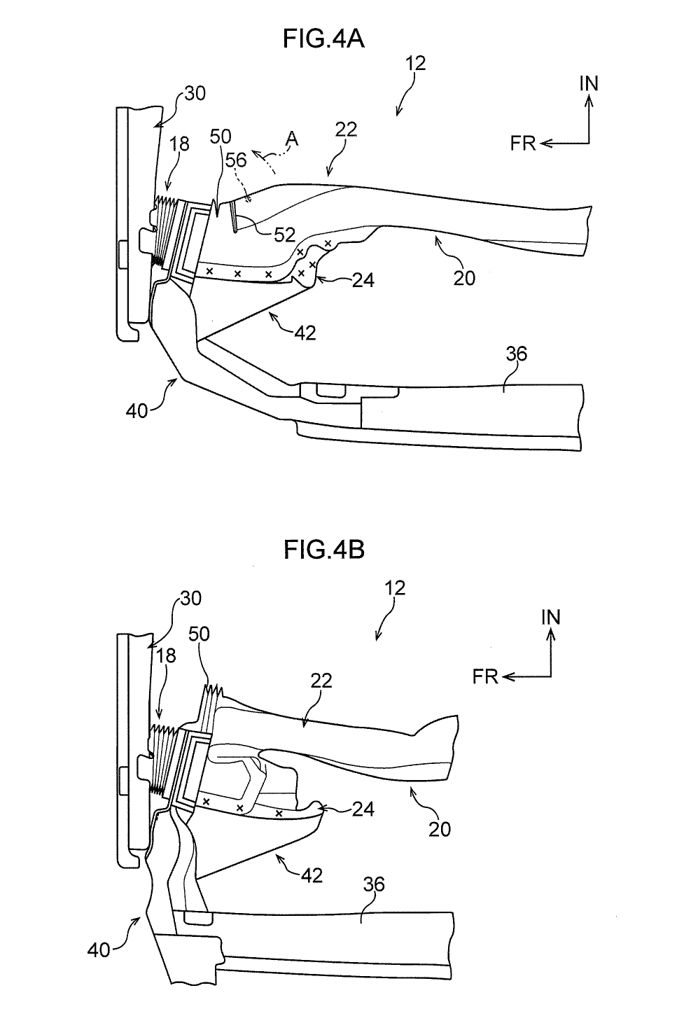

The front side outer member 24 illustrated in FIG. 3 includes an outer upright wall portion 24A that is disposed opposing the inner upright wall 22A of the front side inner member 22 at the vehicle width direction outside. An upper flange 24B extends from an upper end portion of the outer upright wall portion 24A. The upper flange 24B extends toward the vehicle width direction outside at a front portion of the front side outer member 24, and extends toward the vehicle upper side at a front-rear direction intermediate portion and rear portion of the front side outer member 24. The upper flange 24B of the front side outer member 24 is superimposed with the upper flange 22D of the front side inner member 22 and joined thereto by spot welding. Note that in FIG. 1 and FIG. 3, the spot weld strike points (spot welded portions) are indicated by “×” (this also applies to FIG. 4A and FIG. 4B).

As illustrated in FIG. 3, at the front portion of the front side member 20, a vehicle width direction inside end portion of the upper wall 42A of the gusset 42 is superimposed with a lower face side of the upper flange 24B of the front side outer member 24, and spot welding is performed in a three-layer superimposed state. Note that part of the vehicle width direction inside end portion of the upper wall 42A of the gusset 42 is spot welded to the upper flange 24B of the front side outer member 24 in a two-layer superimposed state.

A lower flange 24C, serving as an upright wall shaped upright flange portion, extends from a lower end portion of the outer upright wall portion 24A of the front side outer member 24. A front portion of the lower flange 24C is set within the vehicle front-rear direction range 48, illustrated in FIG. 2, where the gusset 42 is disposed. As illustrated in FIG. 3, the lower flange 24C of the front side outer member 24 is superimposed with the lower flange 22E of the front side inner member 22 on the vehicle width direction outside, and is joined thereto by spot welding.

Note that intervals in the vehicle front-rear direction between the spot weld strike points of the lower flange 22E of the front side inner member 22, and the lower flange 24C of the front side outer member 24 are, for example, substantially the same as intervals in the vehicle front-rear direction between the spot weld strike points of the upper flange 22D of the front side inner member 22, and the upper flange 24B of the front side outer member 24. Regarding the lower flange 22E of the front side inner member 22 and the lower flange 24C of the front side outer member 24, spot weld strike points where the lower flanges 22E, 24C illustrated in FIG. 3 are joined together are set also within the vehicle front-rear direction range 48, illustrated in FIG. 2, where the gusset 42 is disposed, at the vehicle rear side of a front side upright bead 50, described in detail later.

At a front portion of the front side member 20, a lower flange 42F hanging down from a vehicle width direction inside end portion of the lower wall 42B of the gusset 42 is superimposed with the lower flange 24C of the front side outer member 24 from the vehicle width direction outside, and is spot welded thereto in a three-layer superimposed state.

A closed cross-section portion 46 is thereby formed between the gusset 42 and the front side outer member 24. A structure is moreover achieved in which the gusset 42 reinforces the front side outer member 24 side of the front side member 20.

As illustrated in FIG. 1 and FIG. 2, the front side inner member 22 is formed with the front side upright bead 50, angled beads 52, 54 (see FIG. 1), and an intermediate upright bead 56, respectively serving as weakened portions, within the vehicle front-rear direction range 48 where the gusset 42 is disposed (see FIG. 2).

The front side upright bead 50 and the intermediate upright bead 56 are set in the inner upright wall 22A, and extend along the vehicle up-down direction indented toward the vehicle width direction outside. The front side upright bead 50 is set at a front side within the vehicle front-rear direction range 48 where the gusset 42 is disposed (see FIG. 2). As illustrated in FIG. 1, an upper end of the front side upright bead 50 intersects a ridge L1 at a boundary portion between the inner upright wall 22A and the inner upper wall 22B, and a lower end of the front side upright bead 50 intersects a ridge L2 at a boundary portion between the inner upright wall 22A and the inner lower wall 22C (see FIG. 3). The intermediate upright bead 56 is set at the vehicle rear side of the front side upright bead 50, at a vehicle front-rear direction intermediate portion of the vehicle front-rear direction range 48 where the gusset 42 is disposed (see FIG. 2). In the present exemplary embodiment, as an example, the upper end of the intermediate upright bead 56 does not intersect the ridge L1, and the lower end of the intermediate upright bead 56 does not intersect the ridge L2.

The vehicle front-rear direction positions of the angled beads 52, 54 are set between the respective positions of the front side upright bead 50 and the intermediate upright bead 56 in the vehicle front-rear direction. The angled bead 52 is set in the upper wall inclined portion 22B2, and extends along the upper wall inclined portion 22B2 in an inclined direction, indented substantially toward the vehicle lower side. A vehicle width direction inside end portion of the angled bead 52 intersects with the ridge L1, and a vehicle width direction outside end portion of the angled bead 52 intersects a ridge La at a boundary portion between the upper wall inclined portion 22B2 and the upper wall general portion 22B1. The angled bead 54 is set in the lower wall inclined portion 22C2 illustrated in FIG. 3, and extends along the lower wall inclined portion 22C2 in an inclined direction, indented substantially toward the vehicle upper side. As illustrated in FIG. 1, a vehicle width direction inside end portion of the angled bead 54 intersects the ridge L2, and a vehicle width direction outside end portion of the angled bead 54 intersects with a ridge Lb at a boundary portion between the lower wall inclined portion 22C2 and the lower wall general portion 22C1 illustrated in FIG. 3.

### Operation and Advantageous Effects of the Exemplary Embodiment

Explanation follows regarding operation and advantageous effects of the exemplary embodiment described above.

According to the configuration of the present exemplary embodiment, in the event of a small overlap collision, collision load is input to the gusset 42 illustrated in FIG. 2, and transmitted from the gusset 42 to the front side member 20. The front side member 20 deforms (folds inwards), absorbing collision energy, and the front side member 20 moreover pushes the power unit 14 toward the opposite side to the collision.

The front side inner member 22 is formed with the front side upright bead 50, the angled beads 52, 54 (see FIG. 1), and the intermediate upright bead 56, respectively serving as weakened portions within the vehicle front-rear direction range 48 where the gusset 42 is disposed. Accordingly, in the event of a head-on collision (or in the event of an offset collision, in which collision load is received by only one of the front side members 20), as illustrated in FIG. 4, the front side inner member 22 deforms about the beads that are weakened portions within the vehicle front-rear direction range 48 where the gusset 42 is disposed, such as the front side upright bead 50 (see FIG. 2). In contrast, deformation of the front side outer member 24 is suppressed due to being restrained by the gusset 42, such that the front side inner member 22 attempts to displace toward the vehicle front side relative to the front side outer member 24. Shear force accordingly acts on the spot weld strike points between the front side inner member 22 and the front side outer member 24, and the front side inner member 22 deforms while separating from the front side outer member 24, so as to transition from the state illustrated in FIG. 4A to the state illustrated in FIG. 4B, thereby absorbing collision energy.

In the present exemplary embodiment, the above action enables the deformation stroke of the front side member 20 to be increased in comparison to a comparative structure in which, for example, the front side inner member 22 is not provided with weakened portions such as the front side upright bead 50. The desired amount of energy absorption can accordingly be attained by the vehicle front section 12 in the event of a head-on collision or an offset collision, without taking measures such as extending a front overhang or increasing the load bearing strength of the front side members. The configuration of the present exemplary embodiment accordingly enables both weight and cost to be suppressed in comparison to the comparative structure mentioned above.

As illustrated in FIG. 2, in the present exemplary embodiment the gusset 42 is disposed at the front end side of the front side member 20. Collision load is accordingly input to the gusset 42 at an early stage in the event of a small overlap collision. Moreover, as illustrated in FIG. 1, the front side upright bead 50, the angled beads 52, 54, and the intermediate upright bead 56 are provided at the front end side of the front side inner member 22, thus enabling efficient deformation of the front side inner member 22 about the front side upright bead 50, the angled beads 52, 54, and the intermediate upright bead 56, that are on the upstream side in the load transmission direction, from an early stage in the event of a head-on collision.

In the front side member 20 of the present exemplary embodiment, the front side upright bead 50 and the intermediate upright bead 56 are provided to the inner upright wall 22A, thereby weakening the upright wall portion on the vehicle width direction opposite side to the side reinforced by the gusset 42. Accordingly, in the event of a head-on collision, the two vehicle width direction sides of the front side member 20 can be made to comparatively readily undergo relative displacement in the vehicle front-rear direction.

Moreover, as illustrated in FIG. 2, the front side upright bead 50 is set toward the front side within the vehicle front-rear direction range 48 where the gusset 42 is disposed. In the event of a head-on collision, when collision load is input to the vehicle front-rear direction range 48 of the front side member 20 that is reinforced by the gusset 42, then the front side inner member 22 deforms about the front side upright bead 50 as illustrated in FIG. 4A at an early stage. Since the front side upright bead 50 extends in the vehicle up-down direction and is indented toward the vehicle width direction outside (see FIG. 1), collision load from the vehicle front side causes the front side inner member 22 to undergo buckling deformation about the front side upright bead 50, and a location of the front side inner member 22 at the vehicle rear side of the front side upright bead 50 attempts to deform diagonally toward the vehicle width direction inside and front side (refer to the arrow A direction).

Note that the lower flange 22E of the front side inner member 22 and the lower flange 24C of the front side outer member 24 illustrated in FIG. 3 are respectively configured in upright wall shapes, and are superimposed with each other in the vehicle width direction and spot welded together. As illustrated in FIG. 3, the lower flanges 22E, 24C are also set with spot weld strike points within the vehicle front-rear direction range 48, illustrated in FIG. 2, where the gusset 42 is disposed, at the vehicle rear side of the front side upright bead 50. Accordingly, as illustrated in FIG. 4A, when the location of the front side inner member 22 to the vehicle rear side of the front side upright bead 50 attempts to deform diagonally toward the vehicle width direction inside and front side (refer to the arrow A direction), a shear load and a separating load (refer to the arrow A direction) act on the spot welded locations of the lower flanges 22E, 24C illustrated in FIG. 3 that are at the vehicle rear side of the front side upright bead 50 (see FIG. 2). These spot welded locations accordingly separate more efficiently than, for example, spot welded portions on which only shear force acts. Deformation of the front side inner member 22 is accordingly promoted.

As described above, in the vehicle front section structure 10 of the present exemplary embodiment, adequate energy absorption performance can be exhibited by the front side member 20 in the event of a head-on collision, even when the gusset 42 is attached to the vehicle width direction outside of the front side member 20.

### Supplementary Explanation of the Exemplary Embodiment

Note that in the above exemplary embodiment, as illustrated in for example FIG. 2, the gusset 42 serving as a projection member is disposed at the front end side of the front side member 20; however a projection member (a gusset, spacer, or the like) may be set at a vehicle front-rear direction intermediate portion of the front side member 20, or may be set at a rear end side of the front side member 20.

In the above exemplary embodiment, the crash box 18 is disposed inline directly to the vehicle front side of the front side member 20; however, for example, a structure may be configured in which the front side member is joined directly to the bumper reinforcement, rather than through a crash box.

The crash box 18 is preferably disposed inline directly to the vehicle front side of the front side member 20, as in the exemplary embodiment described above; however for example, a configuration may be employed in which a vehicle width direction outside location of a crash box overlaps with a portion of a projection member as viewed from in front of the vehicle.

In the exemplary embodiment described above, the front side upright bead 50 and the intermediate upright bead 56 are provided as weakened portions of the inner upright wall 22A; however weakened portions may be provided exclusively to locations other than the inner upright wall 22A, such as at the upper wall inclined portion 22B2, the lower wall inclined portion 22C2, and so on, illustrated in FIG. 3.

In the above exemplary embodiment, the front side upright bead 50, the angled beads 52, 54, and the intermediate upright bead 56 illustrated in FIG. 1 are indented from the cross-section outside toward the cross-section inside of the front side member 20; however the weakened portions may be weakened portions with other configurations, such as beads protruding out from the cross-section inside toward the cross-section outside of the front side member, thinned portions, or through holes (for example slits extending in the vehicle up-down direction).

Plural weakened portions are preferably provided, as in the above exemplary embodiment; however configuration may be made with a single weakened portion. Moreover, the inner member is preferably set with a weakened portion toward the front side of a vehicle front-rear direction range where a projection member is disposed; however the weakened portion may also be set exclusively at other positions.

As a modified example of the above exemplary embodiment, upper flanges, serving as upright flange portions respectively configured in upright wall shapes that are superimposed on each other along the vehicle width direction and spot welded together, may be formed to respective upper end portions of the inner member and the outer member of the front side member. Such upper flanges may moreover be set with spot weld strike points within a vehicle front-rear direction range where a projection member is disposed, at the vehicle rear side of a front side upright bead.

As another modified example of the above exemplary embodiment, the inner member and the outer member of the front side member may be set with only lateral wall shaped lateral flange portions, without setting upright wall shaped upright flange portions, with the lateral flange portions being welded together by spot welding.

As illustrated in FIG. 3, for example, in the exemplary embodiment described above, the gusset 42 is spot welded together with the front side outer member 24 and the front side inner member 22 in a three-layer superimposed state; however the projection member may be joined by spot welding to the outer member alone. The projection member may, for example, be configured in a polygonal tube shape, such as a triangular tube shape, and be fastened by bolts to an outer upright wall portion of the outer member. However, in such a configuration, since the bolt-fastened portion is separated from spot welded portions between the inner member and the outer member, it is conceivable that load may not be concentrated on the spot welded portions in the event of a head-on collision, with deformation occurring at a location between the bolt-fastened portion and the spot welded portions. A configuration such as that in the exemplary embodiment described above is accordingly preferable from the perspective of separating the inner member and the outer member in the event of a head-on collision.

In the above exemplary embodiment, configuration is made with a similar structure (a structure with left-right symmetry) to the structure illustrated in FIG. 1 provided on the right hand side of the vehicle; however configuration may be made with the gusset 42 and the weakened portions (the front side upright bead 50, the angled beads 52, 54, and the intermediate upright bead 56) only provided on one side in the vehicle width direction.

Note that the above exemplary embodiment and the plural modified examples described above may be combined as appropriate.

Explanation has been given above regarding an example of the present invention, however it goes without saying that various modifications may be implemented within a range not departing from the spirit of the present invention.

What is claimed is:

1. A vehicle front section structure comprising:
a front side member that is disposed along a vehicle front-rear direction at a vehicle width direction outside of a vehicle front section, and that includes an inner member and an outer member forming a closed cross-section portion extending in the vehicle front-rear direction; and
a projection member disposed at the vehicle width direction outside of the front side member and attached to the outer member so as to project out further toward the vehicle width direction outside than the front side member,
wherein a weakened portion is provided at the inner member in a vehicle front-rear direction range where the projection member is disposed.

2. The vehicle front section structure of claim 1, wherein the projection member is disposed at a front end side of the front side member.

3. The vehicle front section structure of claim 1, wherein the weakened portion is provided at the inner member at an inner upright wall configuring a vehicle width direction inside face of the front side member.

4. The vehicle front section structure of claim 2, wherein the weakened portion is provided at the inner member at an inner upright wall configuring a vehicle width direction inside face of the front side member.

5. The vehicle front section structure of claim 3, wherein:
the weakened portion includes a front side upright bead that is set toward the front side of the vehicle front-rear direction range where the projection member is disposed, that extends in a vehicle up-down direction, and that is indented toward the vehicle width direction outside; and
the inner member and the outer member are respectively formed with upright flange portions that are configured in upright wall shapes and are superimposed on each other along the vehicle width direction and spot welded together, and spot weld strike points are set on the upright flange portions at the vehicle rear side of the front side upright bead and within the vehicle front-rear direction range where the projection member is disposed.

6. The vehicle front section structure of claim 4, wherein:
the weakened portion includes a front side upright bead that is set toward the front side of the vehicle front-rear direction range where the projection member is disposed, that extends in a vehicle up-down direction, and that is indented toward the vehicle width direction outside; and
the inner member and the outer member are respectively formed with upright flange portions that are configured in upright wall shapes and are superimposed on each other along the vehicle width direction and spot welded together, and spot weld strike points are set on the upright flange portions at the vehicle rear side of the front side upright bead and within the vehicle front-rear direction range where the projection member is disposed.
